(19) United States
(12) Patent Application Publication
(10) Pub. No.: US 2005/0194263 A1
(43) Pub. Date: Sep. 8, 2005

(54) Electrochemical water purification system and method

(76) Inventor: Ronald Miziolek, Rockwood (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/790,054

(22) Filed: Mar. 2, 2004

(51) Int. Cl. C02F 1/461; C25D 17/00

(52) U.S. Cl. 205/751; 205/761; 204/267; 204/276

(57) ABSTRACT

A system and method for removing contaminants from water. Water with contaminants is passed through a series of three electrochemical cells powered by a direct current source. The first and third electrochemical cells have anodes formed from a non-ferrous material, while the second electrochemical cell is formed from a ferrous material. The iron dissolved in the second cell acts as a flocculent and adsorptive for a variety of contaminants, while hydrogen peroxide and other oxidants formed in the electrochemical cells react with biological entities and other contaminants. The resulting insoluble materials are then filtered.

### FIELD OF THE INVENTION

This invention relates to the field of water purification and more specifically to the purification of water using a series of electrochemical cells.

### BACKGROUND

A variety of methods of water purification have been developed to remove biological contaminants, metals, heavy metals, carbonates, nitrates and other contaminants.

The methods used to date have been inefficient or unsatisfactory in the removal of contaminants from water. Chemical oxidation methods are currently used to remove contaminants from water. However, such methods are known to produce hazardous by-products. Resin based ion exchange systems require frequent regeneration with salts or chemicals and return both the original contaminants and the salts and chemicals into the water supply and consume a significant amount of treated water at the same time. California and many other states have either legislated against or are contemplating legislation preventing the use of systems which produce such highly concentrated waste streams. Similarly, reverse osmosis systems must be regularly backwashed and send a highly concentrated package of contaminants and pathogens back into the water supply. Ultraviolet treatment of water has also been used to deactivate pathogens in water. However, recent research suggests that the pathogen inactivation by the UV systems may not be permanent.

Arsenic has been a particularly problematic contaminant as it has been linked with many types of cancer. In recent years, the United States Environmental Protection Agency has lowered the arsenic limit to 10 μg/L.

U.S. Pat. No. 6,264,845 to Higby et al. shows the use of a single electrochemical cell to remove arsenic from water. The apparatus includes an iron anode and a cathode. When a sufficient voltage is applied, the patent states that adsorbed cations are formed on the anode leading to the formation of ferric arsenate. However, in practice, the plating of the cations inhibits the multi-step formation of ferric arsenate. This method was found to be inefficient in the complete oxidation of As(III) to As(V) and in the complete oxidation of the iron to Fe(III). In addition, insufficient iron was provided to complete the adsorption of arsenic and/or completely bind the arsenic and iron species in all but specific lab situations.

U.S. Pat. No. 5,368,703 issued to Brewster electrochemically donates iron, then further requires the dosing of sufficient hydrogen peroxide to complete the oxidation.

It may further be noted that neither of these prior methods has reached commercialization to date.

It may further be noted that these prior art patents are limited to the removal of arsenic alone.

Therefore, there is needed a system and method of removing contaminants from water efficiently.

### SUMMARY

Described herein are systems and methods for removing contaminants from contaminated water.

The first step of one method involves passing the contaminated water through a first electrochemical cell. The first electrochemical cell has a first anode, a first cathode and a first direct current source. The first anode and first cathode are connected to the first direct current source such that the first anode is normally positively charged and the first cathode is normally negatively charged.

In the second step, the contaminated water is passed through a second electrochemical cell. The second electrochemical cell has a second anode, a second cathode and a second direct current source. The second anode and second cathode are connected to the second direct current source such that the second anode is normally positively charged and the second cathode is normally negatively charged.

In the third step of the method, the contaminated water is passed through a third electrochemical cell. The third electrochemical cell has a third anode, a third cathode and a third direct current source. The third anode and third cathode are connected to the third direct current source such that the third anode is normally positively charged and the third cathode is normally negatively charged. All three anode/cathode cells may be supplied from a single current source.

The contaminated water is then passed through a media filter to remove any particulates therein.

The first anode may be formed from a non-ferrous material and the second anode may be formed from a ferrous material. The third anode may be formed from a non-ferrous material.

At least one of the direct current sources may be adapted to provide a residual ripple.

In another aspect of the present invention, the electrochemical cells are mounted substantially adjacent to one another. The first, second and third electrochemical cells together comprise a single composite electrochemical cell, and the first, second and third cathodes of the three electrochemical cells together comprise a unitary cathode. The first, second and third anodes of the electrochemical cells together comprise a single composite anode having at least three distinct sections. Each of the three distinct sections may be formed from one of at least two materials, the materials chosen such that no two adjacent sections are formed from the same material. One of the at least two materials may be a ferrous material.

In an alternative embodiment of the present invention, a method of removing arsenic in the form of As(III) ions from an aqueous solution has been discovered. Using this method involves first electrochemically oxidizing the As(III) ions to As(V) ions. After this is performed Fe(II) ions are added to the aqueous solution. The Fe(II) ions are then electrochemically oxidized to Fe(III) ions. Finally, the resulting ferric arsenate from the aqueous solution.

The Fe(II) ions may be added by passing the aqueous solution through an electrochemical cell having a ferrous anode.

The electrochemical oxidation of the As(III) ions may be performed in an electrochemical cell has a non-ferrous anode.

The electrochemical oxidation of the Fe(II) ions may be at least partially performed in an electrochemical cell having a non-ferrous anode.

The step of removing the ferric arsenate from the aqueous solution may be performed by passing the aqueous solution through a filter.

Also provided herein is a contaminant reduction system for the reduction of contaminants in water from a water source. The system includes an inlet for receiving the water from the water source. The system also includes three electrochemical cells in fluid communication with one another and with the inlet, where each of the electrochemical cells has an anode and a cathode. At least one direct current source is connected to the anodes and cathodes. A filter is provided to remove insoluble particles proximate to an outlet in fluid communication with the inlet.

In another aspect of the present invention, at least one of the anodes of the system may be formed from a non-ferrous material. At least one of the anodes may formed from a ferrous material.

The three electrochemical cells together comprise a single composite electrochemical cell while the cathodes of the three electrochemical cells together comprise a unitary cathode.

The anodes of the electrochemical cells may together comprise a single composite anode having at least three distinct sections. Each of the three distinct sections may be formed from one of at least two materials. The materials are chosen such that no two adjacent sections are formed from the same material. One of the at least two materials may be a ferrous material.

In a further alternative to the methods and systems described above, the ferrous anode may instead be replaced with an aluminum anode. The aluminum anode may provide activated alumina to the solution.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which presently preferred embodiment(s) of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic of an electrochemical water purification system in accordance with the present invention; and

FIG. 2 is a schematic of an alternative embodiment of an electrochemical water purification system in accordance with the present invention.

### DETAILED DESCRIPTION

The novel features which are believed to be characteristic of the present invention, as to its structure, organization, use and method of operation, together with further objectives and advantages thereof, will be better understood from the following discussion in combination with the accompanying drawings.

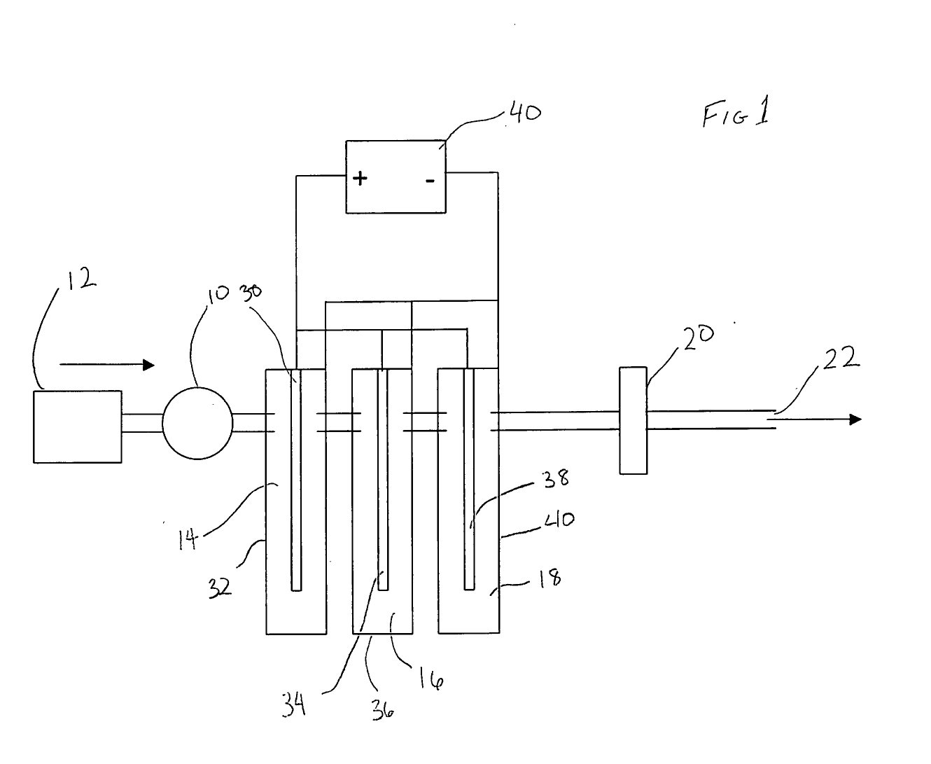

As shown in the accompanying figures, a system of water purification is provided for the removal of a variety of contaminants from water. In FIG. 1, contaminated water is provided with contaminated water from a pressurized water source 12 into a first electrochemical cell 14, through a second electrochemical cell 16 and a third electrochemical cell 18. After the third electrochemical cell 18, the contaminated water passes through a filter 20 into an outlet 22. (A pump 10 may be used to deliver the contaminated water from water source 12.)

First electrochemical cell 14 is composed of a non-ferrous anode 30 and a cathode 32. Second electrochemical cell 16 is composed of a ferrous anode 34 and a cathode 36. Third electrochemical cell 18 is composed of a non-ferrous anode 38 and a cathode 40.

In the first electrochemical cell 14, the majority of the contaminants are oxidized. In the second electrochemical cell 16, the anode 34 donates iron, which is a flocculating, adsorbing, and binding agent, and enhances hydroxyl ion production from the water. The third cell 18 ensures that the oxidation is complete and ensures a residual amount of hydrogen peroxide remains in the water.

Filter 20 is capable of filtering insoluble particles in the water. For example, filters of varying pore sizes are often used in drinking water applications. Depending on the application, other filters types can also be used with a variety of pore sizes.

Each of the anodes and cathodes are connected to an electrical source 40 for applying positive and negative charges, respectively. Preferably, the electrical source is a DC power supply. Generally speaking, DC power supplies are designed to provide minimal ripple. However, a DC power supply with a residual ripple may be useful in this application to prevent plating of compounds on the anodes. Alternatively, the DC power supply may providing a pulsing DC current, (i.e. the current is switched off at intervals). The power required to remove the contaminants is dependent on the concentration of contaminants, the flow rate, the type of contaminants and the surface areas of the anode and cathode relative.

Arsenic

Arsenic in groundwater is most often in the form of arsenite (As(III). In the first electrochemical cell, the arsenite undergoes oxidation to arsenate (As(V)). As well, in the first electrochemical cell water undergoes the following electrochemical reactions:
2H₂O→2H⁺+O₂+2e⁻
2H₂O→2H⁺+H₂O₂+2ₑ⁻

The arsenite (in the form of an arsenous acid) may also react with the hydrogen peroxide to form arsenate:
H₃AsO₃+H₂O₂→H₂AsO₄⁻+H⁺+H₂O

In the second electrochemical cell, Fe(II) ions are generated by the anode and are dissolved in the water. Iron is a general purpose flocculent, and adsorbtive.
Fe→Fe²⁺+2e⁻

The Fe(II) ions undergo oxidation in the second and third electrochemical cells to form Fe(III) ions either directly at the anodes or by reacting with the hydrogen peroxide:
2Fe²⁺+H₂O₂+2H⁺→2Fe³⁺+2H2O

In both the second and third cells, the Fe(III) ions react form ferric hydroxide:
Fe³⁺+3H₂O→Fe(OH)₃+3H⁺

The ferric hydroxide will react with and adsorb the arsenate ions to form ferric arsenate:
Fe(OH)₃+H₂AsO₄⁻→FeAsO4.2H₂O+H₂O

The ferric arsenate is a precipitate which is then captured by filter 20. Ferric arsenate meets the EPA leachite guidelines and is approved for disposal in sanitary landfill.

The advantage of using a single ferrous anode and two non-ferrous anodes in the system is best realized in the removal of arsenic. The As(V) ions are created in the first electrochemical cell. The Fe(II) ions are released in the second cell and are oxidized to Fe(III) ions in the second and third cells. The iron and arsenate and can then react to form the ferric arsenate precipitate.

While arsenic has been described as the contaminant to be removed, similar reactions may occur with chlorine, sulphur, compounds of the same, metals, other heavy metals and radionucleotides. In fact, many chlorine by-products such as THM are also neutralized by dissociating the chlorine, binding it with iron and removing the ferric chloride from the solution in filters.

Oxidants

The electrochemical oxidation of water may be used to form oxidants such as oxygen (O₂) and hydrogen peroxide (H₂O₂). The following equations illustrate the formation of these oxidants:
2H₂O→2H₂+O₂+2e⁻

2H₂O→2H⁺+H₂O₂+2e⁻

Hydrogen peroxide is effective in removing organics from drinking water. As a result, the second reaction is preferred. It may be possible that limiting the current density of the electrochemical cells will allow the former reaction to occur at a higher reaction rate.

In addition, hydrogen peroxide may be formed from a pair of hydroxyl ions. In the second cell, the following reactions may occur:
Anode: 2Fe→2Fe⁺⁺+4e⁻
Cathode: 2HOH→H₂+2OH⁻
and/or O₂+2H₂O+4e⁻→4OH⁻

The hydroxyl radicals are strong oxidants that react very quickly without the required contact time of other oxidants. The unused hydroxyls will form peroxide:
OH⁻+OH^{-→H}₂O₂

Hydroxyl ions and hydrogen peroxide are well known as highly effective biological oxidants. When cells are subjected to an electrical field, the polarized ions in the cell walls may be attracted to the anode or cathode. The attraction causes electroporation, or the enlargement of the pores in the cell walls. These oxidants can now more easily enter these pores and attack the molecules within the cells.

In addition, hydrolysis may occur within the cells itself through a process known as lysis. The molecules within the cell attracted to the anode pull the cell in one direction, while the molecules within the cell attracted to the cathode cause the cell walls to break apart.

In addition, chlorine by-products such as trihalomethanes have organic precursors which may be removed by reactions with the oxidants.

Carbonates

Two major contaminants which cause water hardness are calcium bicarbonate (Ca(HCO₃)₂) and magnesium bicarbonate (Mg(HCO₃)₂). In the first electrochemical cell, the bicarbonates are broken down by oxidation into the corresponding carbonate, water and carbon dioxide.
Ca(HCO₃)₂→CaCO₃+H₂CO₃

The calcium carbonate is insoluble and will be captured by filter 20. As the carbonates are strongly electronegative, some may plate out onto the anodes in the three electrochemical cells. However, most of the carbonates do not adhere to the anodes and are caught by filter 20.

The carbonic acid (H₂CO₃) will react with any calcium carbonate scaling in the downstream pipes re-dissolving it to soluble calcium bicarbonate. Over a period of time, scale will be removed.
CaCO₃ (as scale)+H₂CO₃ (dissolved CO₂)→Ca(HCO₃)₂

As a result, the water undergoes a softening process and the downstream scaling is slowly dissolved.

Nitrogen Oxides

Nitrogen oxides such as NO₃, NO₂ and NO undergo reduction in the electrochemical cells. The nitrogen oxides will undergo the following reactions:
Cathode: 2NO₃⁻+12H⁺+10e⁻→N₂+6H₂O
Anode: 2H₂O→2H⁺+O₂+4e⁻

These reactions are simplified versions of a multi-step process in which the nitrogen oxides are reduced. The nitrogen oxides will be converted to nitrogen gas. In cases where contamination of the treated water is severely high, the amount of gas formed may be high enough to require evacuation from the system. In such cases, the gasses are typically trapped in the head of the filter vessel onto which an air vent connected to the outdoors may be mounted.

Plating

Depending on the extent of contamination of the water source, plating may occur on one or more of the anodes and cathodes. The plating of various compounds on the anodes and cathodes may be enough to impede the electrochemical processes. As plating occurs on the anodes and cathodes due to the polarity of the electrical charge, the reversal of the electrical charge will be sufficient to dislodge the plating compounds. The polarity of the electrical charge can be reversed at the end of a flow cycle. The plating compounds would be dislodged and could simply be caught by filter 20 when flow is re-initiated.

The switching of the polarity can be performed at the end of a flow cycle, after a set number of flow cycles, after a set volume of water or as initiated by the user.

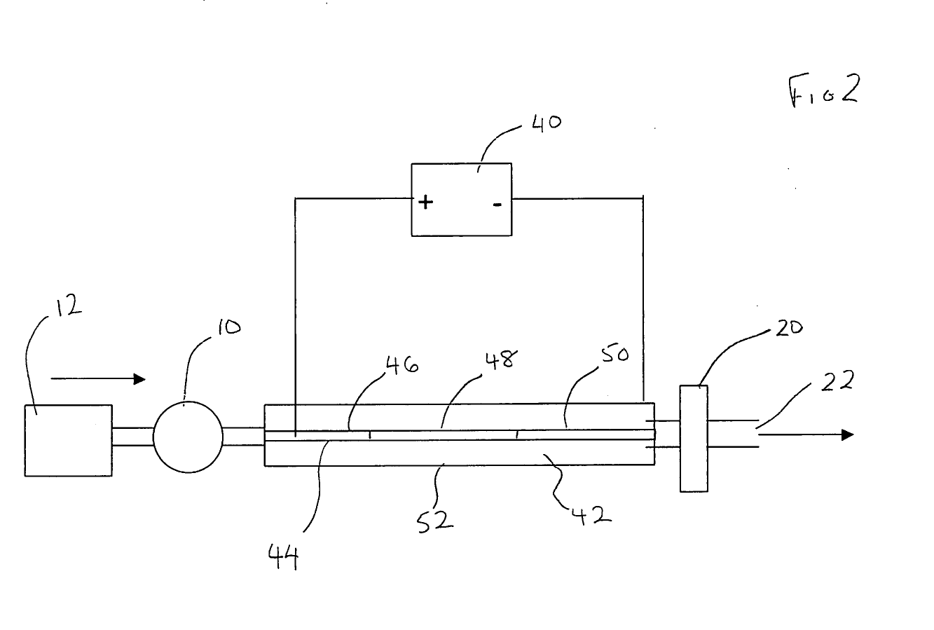

To this point, the electrochemical cells have been shown as distinct chambers. In an alternative embodiment, a single electrochemical cell 42 could replace the three separate cells. In this embodiment, a long, central anode 44 would pass along the central axis of a hollow cylindrical cathode 52, as shown in FIG. 2. The central anode would be composed of three distinct sections. The first section 46 near the inlet would be made of a non-ferrous material. The second section 48 in the middle would be made of a ferrous material. The third section 50 near the outlet would also be made of a non-ferrous material. In essence, this configuration is identical to the one shown in FIG. 1, except that the electrochemical cells are joined together more directly. The cathode is then common to all three anodes.

In a further alternative, the iron anode may be replaced with an aluminum anode. When the current is applied to the electrochemical cell, the aluminum anode will release activated alumina into the solution. The activated alumina will react with the arsenate to form aluminum arsenate. Aluminum arsenate is insoluble and will be captured in the downstream filter.

In a still further embodiment, the iron anode could be replaced with other metallic metallic anodes, depending on the contaminant in the water. The metallic compound would donate ions when connected to an active direct current source. The ions, either alone or after additional oxidation, would then react with the desired contaminant to form an insoluble compound. Examples of such metallic anodes include iron and aluminum (as discussed above) or possibly copper, zinc, silver, magnesium, nickel or compounds or alloys of these materials.

It will be obvious to those skilled in the art that a variety of electrochemical cells can be used with the present system and still prove effective. The systems and methods described herein may be used to provide potable water in a variety of situations. For example, an undersink system may be employed to purify water at a single tap. A larger system could be used at the point of entry of water in a home. A still larger system could be used for industrial applications. A still larger system could be used in municipal applications.

Other variations of the above principles will be apparent to those who are knowledgeable in the field of the invention, and such variations are considered to be within the scope of the present invention. Other modifications and/or alterations may be used in the design and/or manufacture of the apparatus of the present invention, without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially perpendicular is intended to mean perpendicular, nearly perpendicular and/or exhibiting characteristics associated with perpendicularity.

1. A method for removing contaminants from contaminated water, said methods comprising the steps of:
(a) passing the contaminated water through a first electrochemical cell, said first electrochemical cell having a first anode, a first cathode and a first direct current source, said first anode and first cathode being connected to said first direct current source such that said first anode is normally positively charged and said first cathode is normally negatively charged;
(b) passing the contaminated water through a second electrochemical cell, said second electrochemical cell having a second anode, a second cathode and a second direct current source, said second anode and second cathode being connected to said second direct current source such that said second anode is normally positively charged and said second cathode is normally negatively charged;
(c) passing the contaminated water through a third electrochemical cell, said third electrochemical cell having a third anode, a third cathode and a third direct current source, said third anode and third cathode being connected to said third direct current source such that said third anode is normally positively charged and said third cathode is normally negatively charged;
(d) passing the contaminated water through a media filter to remove any particulates therein.

2. A method as claimed in claim 1, wherein said first anode is formed from a non-ferrous material and said second anode is formed from a ferrous material.

3. A method as claimed in claim 1, wherein said first anode is formed from a non-ferrous material and said second anode is formed from aluminum.

4. A method as claimed in claim 2, wherein said third anode is formed from a non-ferrous material.

5. A method as claimed in claim 1, wherein said second anode is formed from a metallic material, said metallic material being selected such that the ions released in the contaminated water while said second anode is connected to said second direct current source tend to react with said contaminant to form a compound insoluble in water.

6. A method as claimed in claim 1, wherein at least one of said direct current sources is adapted to provide a residual ripple.

7. A method as claimed in claim 1, wherein each of said electrochemical cells are mounted substantially adjacent to one another.

8. A method as claimed in claim 1, wherein said first, second and third electrochemical cells together comprise a single composite electrochemical cell, and wherein said first, second and third cathodes of said three electrochemical cells together comprise a unitary cathode.

9. A method as claimed in claim 8, wherein said first, second and third anodes of said electrochemical cells together comprise a single composite anode having at least three distinct sections.

10. A method as claimed in claim 9, wherein each of said three distinct sections are formed from one of at least two materials, said materials chosen such that no two adjacent sections are formed from the same material.

11. A method as claimed in claim 10, wherein one of said at least two materials is a ferrous material.

12. A method as claimed in claim 10, wherein one of said at least two materials is aluminum.

13. A method of removing arsenic in the form of As(III) ions from an aqueous solution, said method comprising the steps of:
(a) electrochemically oxidizing the As(III) ions to As(V) ions;
(b) adding Fe(II) ions to the aqueous solution;
(c) electrochemically oxidizing the Fe(II) ions to Fe(III) ions; and
(d) removing the resulting ferric arsenate from the aqueous solution.

14. A method as claimed in claim 13 wherein said Fe(II) ions are added by placing the aqueous solution in an electrochemical cell having a ferrous anode.

15. A method as claimed in claim 13 wherein said electrochemical oxidation of said As(III) ions is performed in an electrochemical cell having a non-ferrous anode.

16. A method as claimed in claim 13, wherein the step of electrochemically oxidizing said Fe(II) ions is at least partially performed in an electrochemical cell having a non-ferrous anode.

17. A method as claimed in claim 13, wherein the step of removing the ferric arsenate from the aqueous solution is performed by passing said aqueous solution through a filter.

18. A contaminant reduction system for the reduction of contaminants in water from a water source, the system comprising:
(a) an inlet for receiving the water from the water source;
(b) three electrochemical cells in fluid communication with one another and with said inlet, each of said electrochemical cells having an anode and a cathode;
(c) at least one direct current source connected to said anodes and cathodes;
(d) a filter for removing insoluble particles; and
(e) an outlet in fluid communication with said inlet.

19. A contaminant reduction system as claimed in claim 18, wherein at least one of said anodes is formed from a non-ferrous material.

20. A contaminant reduction system as claimed in claim 18, wherein at least one of said anodes is formed from aluminum.

21. A contaminant reduction system as claimed in claim 18, wherein at least one of said anodes is formed from a ferrous material.

22. A method as claimed in claim 18, wherein said second anode is formed from a metallic material, said metallic material being selected such that the ions released in the contaminated water while said second anode is connected to said second direct current source tend to react with said contaminant to form a compound insoluble in water.

23. A contaminant reduction system as claimed in claim 18, wherein said three electrochemical cells together comprise a single composite electrochemical cell, said cathodes of said three electrochemical cells together comprising a unitary cathode.

24. A contaminant reduction system as claimed in claim 23, wherein said anodes of said electrochemical cells together comprise a single composite anode having at least three distinct sections.

25. A contaminant reduction system as claimed in claim 24, wherein each of said three distinct sections are formed from one of at least two materials, said materials chosen such that no two adjacent sections are formed from the same material.

26. A contaminant reduction system as claimed in claim 25, wherein one of said at least two materials is a ferrous material.

27. A contaminant reduction system as claimed in claim 25, wherein one of said at least two materials is aluminum.
